(19) United States
(12) Patent Application Publication
(10) Pub. No.: US 2009/0051860 A1
(43) Pub. Date: Feb. 26, 2009

(54) BLANK, BLACK MATRIX, AND COLOR FILTER

(75) Inventors: Takehiko HIRUMA, Chiyoda-ku (JP); Masahiko Nakamori, Yonezawa-shi (JP); Ryoichi Uryu, Yonezawa-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Asahi Glass Company, Limited, Chiyoda-ku (JP)

(21) Appl. No.: 12/257,771

(22) Filed: Oct. 24, 2008

Related U.S. Application Data
(63) Continuation of application No. PCT/JP2007/058764, filed on Apr. 23, 2007.

(30) Foreign Application Priority Data
Apr. 24, 2006 (JP) 2006-119346

(51) Int. Cl. G02F 1/1335; G02F 1/1333

(52) U.S. Cl. 349/106; 428/1.5

(57) ABSTRACT

An object of the present invention is to provide a black matrix excellent in durability (e.g., water resistance) and patterning property, a color filter formed from the black matrix, and a black matrix. The present invention relates to a blank for a black matrix, comprising a substrate having laminated thereon a light-shielding film and a low-reflection film, wherein the uppermost layer of the blank is the light-shielding film or the low-reflection film, the uppermost layer has an Ni content of from 80 to atm % based on the total metal components, the uppermost layer has an Mo content of from 8 to 15 atm % based on the total metal components, and the uppermost layer is free from Ta.

### TECHNICAL FIELD

The present invention relates to a black matrix for TFT arrays or color filters used in flat panel displays etc. including a color liquid crystal display device.

### BACKGROUND ART

Flat panel displays including a color liquid crystal display device are being increasingly used as an information device, as a monitor display for notebook computers or as a display for dynamic images such as TV images and the like.

In these color liquid crystal display devices, the color filter substrate used for the color liquid display device is provided with a black matrix so as to enhance the display contrast of the image and other display qualities. The black matrix is generally used for the purpose of shading the periphery of the display portion of individual color pixels of three primary colors, i.e., red, green and blue, of a color filter to prevent respective adjacent colors from decoloration and causing color mixture and also for increasing the contrast of color display to improve the display quality.

As regards the material for the black matrix, a metal chromium (Cr) film is usually used for such reasons that in the production process of a color liquid crystal display device, (1) the production is easy, (2) a strong film can be formed, (3) the liquid crystal display panel produced is stable and highly reliable, and (4) satisfactory light shielding characteristics are obtained. Furthermore, in order to make the black matrix low-reflecting, there is employed a method of constructing a laminated film structure by depositing a chromium oxide film, a chromium oxynitride film, a chromium oxycarbide film or the like on at least either one of the front and back surfaces of the metal chromium film. In the metal chromium film and the like, a pattern is formed by utilizing a photolithography technique to produce a black matrix.

The metal chromium film and the like are advantageous in that a high light-shielding degree is attained even by a relatively thin film, a high light shielding property giving an optical density (OD value) of about 4 in the visible light region is relatively easily obtained, and a fine pattern can be formed by a normal photolithography process. However, there is a problem that when patterning the metal chromium film and the like, it involves a large amount of labor and cost, for example, in the handling of an etching solution and the treatment and control of waste.

In order to solve this problem, a photosensitive resin film may be exemplified as a substitute for the metal chromium film. However, a film thickness of approximately from 1.5 to 2.0 μm is necessary for obtaining a light shielding property nearly equal to that of the metal chromium film and, on the other hand, the thickness of each of red, green and blue colored layers constituting the color filter is approximately from 1.0 to 1.5 μm. Therefore, as a result, the overlay portion formed to prevent decoloration in the periphery of a pixel comes to have a step height of about 2 to 3 pn, giving rise to a problem of deteriorating the flatness of the color filter. Also, because of the large thickness of the resin film, the pattern may get chipped or be overhung during development in the photolithography process, and it is hence hard to form a good-precision black matrix.

Furthermore, a film using an Ni—Mo—Fe—Ta-based material has been proposed as a substitute for the metal chromium film (see, for example, Patent Document 1).

Patent Document 1: JP-A-2002-107537

### DISCLOSURE OF THE INVENTION

### Problems to be Solved by the Invention

However, the film using the material disclosed in Patent Document 1 is poor in durability (e.g., water resistance) and patterning property and is not suitable as a product. This is particularly significant in the recent high-precision and high-reliability black matrix or color filter.

An object of the present invention is to provide a black matrix excellent in durability (e.g., water resistance) and patterning property while maintaining properties such as low reflectivity; a color filter formed from the black matrix; a blank for forming the black matrix; a black matrix formed by patterning the blank; and a color filter using the black matrix.

### Means for Solving the Problems

The present invention provides a blank for a black matrix, comprising a substrate having laminated thereon a light-shielding film and a low-reflection film, wherein the uppermost layer of the blank is the light-shielding film or the low-reflection film, the uppermost layer has an Ni content of from 80 to 92 atm % based on the total metal components, the uppermost layer has an Mo content of from 8 to 15 atm % based on the total metal components, and the uppermost layer is free from Ta.

### ADVANTAGES OF THE INVENTION

The black matrix of the present invention is preferred because good durability (e.g., water resistance) and good patterning property are attained by being free from Ta in the uppermost layer. The etching rate is also good. Furthermore, an Ni—Mo alloy is used as the main component, so that a firm film assured of satisfactory light shielding property and easy production can be formed.

It is preferred that the uppermost layer contains nitrogen, since the patterning performance is further improved thereby.

The blank before patterning into the black matrix has the same effects as above. The color filter formed using the black matrix of the present invention has improved display quality as compared with conventional color filters.

### BRIEF DESCRIPTION OF THE DRAWINGS

FIG. 1 is a schematic cross-sectional view showing one embodiment of the blank of the present invention.

FIG. 2 is another schematic cross-sectional view showing one embodiment of the blank of the present invention.

### DESCRIPTION OF REFERENCE NUMERALS AND SIGNS

1: Blank
11: Substrate
12: Low-reflection film
13: Light-shielding film
21: First low-reflection film
22: Light-shielding film
23: Second low-reflection film

### BEST MODE FOR CARRYING OUT THE INVENTION

The blank of the present invention is a precursor for producing a black matrix, and a black matrix can be formed by patterning the blank.

The blank of the present invention is obtained by laminating a light-shielding film and a low-reflection film on a substrate. The light-shielding film is a film for shading the periphery of the display portion of individual color pixels of three primary colors, i.e., red, green and blue, of a color filter to prevent respective adjacent colors from decoloration, and the low-reflection film is a film formed to impart low reflectivity to the film. In the blank of the present invention, a light-shielding film and a low-reflection film are laminated in an arbitrary order. However, in view of the requirement for low reflectivity, a blank formed by laminating a low-reflection film and a light-shielding film in this order on a substrate is preferred. A low-reflection film may be further provided on the light-shielding film. Also, a layer other than the light-shielding film and the low-reflection film may be provided to the extent enabling use as a black matrix.

In the blank of the present invention, the uppermost layer of the black is free from Ta. The uppermost layer as used herein means the film most distant from the substrate and refers to the film with which a photoresist comes into contact when the blank is patterned.

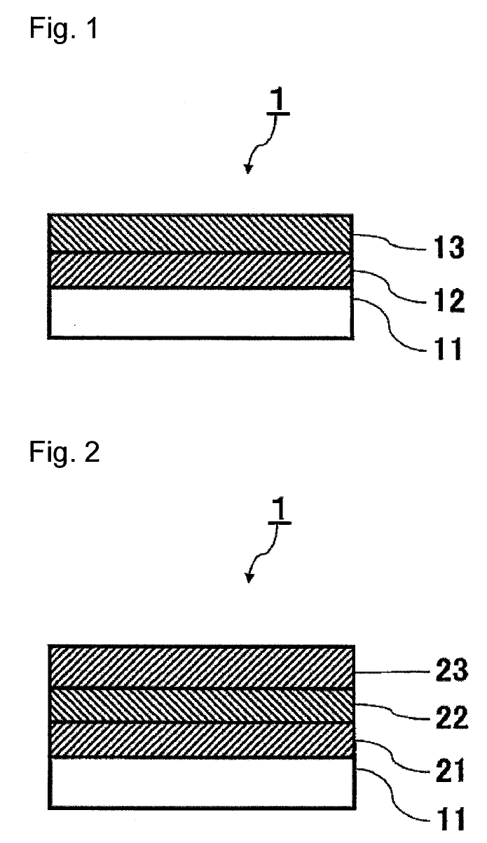

For example, as shown in FIG. 1, when a blank 1 is obtained by laminating a low-reflection film 12 and a light-shielding film 13 in this order on a substrate 11, the uppermost layer is the light-shielding film 13. Also, as shown in FIG. 2, when a blank 1 is obtained by laminating a first low-reflection film 21, a light-shielding film 22 and a second low-reflection film 23 in this order on a substrate, the uppermost layer is the second low-reflection film 23. Incidentally, the first low-reflection film 21 and the second low-reflection film 23 may be the same or different in composition, etc.

The expression “free from Ta” means that when the film is evaluated by ICP emission spectrometry, the Ta content in the film is 0.1 atm % or less based on the total metal elements. As described above, when the uppermost layer is free from Ta, the water resistance and patterning property are improved, which is hence preferred. Incidentally, the thickness of the film being free from Ta is preferably 5 nm or more for bringing out the effect in terms of water resistance, patterning property and the like.

Ta per se is a metal having very excellent durability such as water resistance. Accordingly, the use or addition of Ta for improving the durability has been heretofore employed, and it is presumed that a Ta alloy is used also in Patent Document 1 as one of the components constituting the black matrix for the same reason.

However, the present inventors found that the addition of Ta brings about deterioration of the water resistance. The reasons therefor are not clearly known, but it is estimated that when a specific amount of Ta is added, the water resistance rather deteriorates due to interaction with other metals.

Furthermore, from the aspect of the treatment or control of a waste, the low-reflection film and/or light-shielding film preferably contain no metal chromium, and it is more preferred that the entire film constituting the blank is free from metal chromium. The expression “free from metal chromium” means that the metal chromium content in the film is 0.1 atm % or less based on the total metal elements.

In Patent Document 1, the addition amount of Ta is preferably 0.5 mass % or more, and the reason therefor is to bring the etching rate close to that of the chromium metal film. As for the reason “to bring the etching rate close to that of the chromium metal film”, it is presumed that it had been considered that the use of a conventional apparatus or conventional etching conditions is important and Ta needs to be contained for this reason. However, as the result of detailed evaluations of patterning property, etc. made this time, it has been found that incorporation of Ta per se may, in fact, be a problem and that the problem may become particularly significant in the case of the uppermost layer.

The substrate for use in the present invention needs not necessary be flat and plate-shaped, but may be curved or of variant form. Specific examples of the substrate include a transparent glass substrate, a ceramic substrate and a plastic substrate. Particularly, a glass substrate is preferred in view of strength and heat resistance. Examples of the glass substrate include a colorless transparent soda lime glass substrate, a quartz glass substrate, a borosilicate glass substrate, and a non-alkali glass substrate. The thickness of the glass substrate is preferably from 0.2 to 1.5 mm in view of strength and transmittance.

In the case where the uppermost layer of the blank of the present invention is a light-shielding film, the light-shielding film contains an Ni—Mo alloy as a main component. In view of durability and patterning property, the total content of Ni and Mo in the light-shielding film is preferably 90 atm % or more, more preferably 93 atm % or more, based on the total metal elements in the light-shielding film.

Incidentally, the following description concerning the composition and characteristic features of the light-shielding film is directed to the case where the light-shielding film is the uppermost layer, and the following composition and characteristic features are not necessarily required when the light-shielding film is not the uppermost layer. However, even in the case where the light-shielding film is not the uppermost layer, it is preferred to satisfy the following composition and characteristic features.

From the standpoint of durability and processability, the Ni content in the light-shielding film is from 80 to 92 atm % based on the total metal components in the light-shielding film. If the Ni content is less than 80 atm %, the durability deteriorates, whereas if it exceeds 92 atm %, the etching rate decreases and it becomes hard to form a black matrix by patterning. Furthermore, if the Ni content exceeds 92 atm %, the target comes to have magnetism and it becomes hard to form the blank by sputtering. The Ni content in the light-shielding film is preferably from 85 to 92 atm %.

From the aspect of durability and processability, the Mo content in the light-shielding film is from 8 to 15 atm % based on the total metal components in the light-shielding film. If the Mo content is less than 8 atm %, the etching rate decreases and it becomes hard to form a black matrix by patterning, whereas if it exceeds 15 atm %, the durability (particularly water resistance) deteriorates. Furthermore, if the Mo content exceeds 15 atm %, the etching rate becomes too high and it becomes hard to carry out stable production in forming the black matrix by patterning. The present inventors found the following. Contrary to conventional common knowledge, the patterning property is deteriorated by the incorporation of Ta and, therefore, the Ta content is to be reduced to a given value or less. However, since the reduction of the Ta content alone makes it difficult to control the etching rate, the values in the above-described range.

The light-shielding film may contain other metals in addition to Ni and Mo. The other metal is preferably Fe, and the Fe content is preferably from 0.5 to 6 atm % based on the total metal components in the light-shielding film. By incorporating Fe in the range above, the water resistance of the black matrix can be improved. If the Fe content is less than 0.5 atm %, the effect can be hardly obtained, whereas if it exceeds 6 atm %, the water resistance rather deteriorates and this is not preferred.

Furthermore, the light-shielding film may contain one metal or two or more metals such as Al, Ti, Zr, V, W and Co within the range not impairing the effects of the present invention, for example, in a content of 15 atm % or less based on the total metal components in the light-shielding film.

The light-shielding film for use in the present invention preferably further contains nitrogen. By the addition of nitrogen, the etching rate can be increased, which is hence effective in controlling the etching rate and which can also improve the patterning property. The content of nitrogen is from 0.5 to 10 atm %, particularly from 1 to 6 atm %, based on the total elements in the light-shielding film. If the content of nitrogen is less than 2 atm %, the effect of improving the patterning property can be hardly obtained, whereas if it exceeds 50 atm %, the light shielding property of the light-shielding film deteriorates and this is not preferred. In the case of forming the light-shielding film by sputtering, the addition of nitrogen into the film can be effected by adding a nitrogen gas to the sputtering gas. The content of nitrogen gas in the sputtering gas is preferably from 2 to 40 vol %, more preferably from 5 to 30 vol %, still more preferably from 1 to 30 vol %, particularly preferably from 2 to 20 vol %. Also, oxygen or carbon may be contained in the light-shielding film within the range not impairing the effects of the present invention, but in view of light shielding property, the total content of oxygen and nitrogen is preferably 4 atm % or less based on the total elements in the light-shielding film.

The light-shielding film may be composed of not only one layer but also two or more layers. When the light-shielding film is composed of two or more layers, the layer that is not the uppermost layer is not particularly limited. However, when the light-shielding film is composed of two or more layers, it is preferred that each of the layers including even the non-uppermost layer(s) has the construction as described above. The light-shielding film may also be a gradient film where the composition gradually changes along the thickness direction.

Furthermore, not only when the light-shielding film is the uppermost layer but also when not the uppermost layer, the composition and characteristic features of the light-shielding film are preferably in the above-described ranges.

In the case where the low-reflection film for use in the present invention is the uppermost layer, the low-reflection film contains an Ni—Mo alloy as a main component. In view of durability and patterning property, the total content of Ni and Mo in the low-reflection film is preferably 90 atm % or more, more preferably 93 atm % or more, based on the total metal atoms.

Incidentally, the following description concerning the composition and characteristic features of the low-reflection film is directed to the case where the low-reflection film is the uppermost layer, and the following composition and characteristic features are not necessarily required when the low-reflection film is not the uppermost layer. However, even in the case where the low-reflection film is not the uppermost layer, it is preferred to satisfy the following composition and characteristic features.

From the standpoint of durability and processability, the Ni content in the low-reflection film is from 80 to 92 atm % based on the total metal components in the low-reflection film. If the Ni content is less than 80 atm %, the durability deteriorates, whereas if it exceeds 92 atm %, the etching rate decreases and it becomes hard to form a black matrix by patterning. Furthermore, if the Ni content exceeds 92 atm %, the target comes to have magnetism and it becomes hard to form the blank by sputtering. The Ni content in the low-reflection film is preferably from 85 to 92 atm % based on the total metal components in the low-reflection film.

From the standpoint of durability and processability, the Mo content in the low-reflection film is from 8 to 15 atm % based on the total metal components in the low-reflection film. If the Mo content is less than 8 atm %, the etching rate decreases and it becomes hard to form a black matrix by patterning, whereas if it exceeds 15 atm %, the durability (particularly water resistance) deteriorates. Furthermore, if the Mo content exceeds 15 atm %, the etching rate becomes too high and it becomes hard to carry out stable production in forming the black matrix by patterning.

Incidentally, when the low-reflection film is not the uppermost layer, the contents need not be in the above-described ranges as long as the patterning rate is in the same level as that of the light-shielding film. Specifically, from the standpoint of durability and processability, the Ni content is preferably from 70 to 92 atm % based on the total metal components of the low-reflection film. Also, from the standpoint of durability and processability, the Mo content is preferably from 8 to 30 atm % based on the total metal components of the low-reflection film.

The low-reflection film may contain other metals in addition to Ni and Mo. The other metal is preferably Fe, and the Fe content is preferably from 0.5 to 6 atm % based on the total metal components in the low-reflection film. By incorporating Fe in the range above, the water resistance can be improved. If the Fe content is less than 0.5 atm %, the effect can be hardly obtained, whereas if it exceeds 6 atm %, the water resistance rather deteriorates and this is not preferred.

Furthermore, the low-reflection film may contain one metal or two or more metals such as Al, Ti, Zr, V, W and Co within the range not impairing the effects of the present invention, for example, in a content of 15 atm % or less based on the total metal components in the low-reflection film.

The low-reflection film preferably further contains oxygen for ensuring the low reflecting performance. Specifically, the content of oxygen is preferably from 5 to 65 atm % based on the total elements in the low-reflection film. In this case, the content of the metal component such as Ni and Mo is preferably from 30 to 80 atm % based on the elements in the entire low-reflection film.

The low-reflection film may further contain nitrogen or carbon. By containing nitrogen or carbon, the etching rate can be controlled. The content of nitrogen is preferably from 0.1 to 50 atm % based on the total elements in the low-reflection film. Also, the total content of oxygen and nitrogen is preferably from 20 to 70 atm % based on the total elements in the low-reflection film. The content of carbon is preferably from 0.1 to 15 atm % based on the total elements in the low-reflection film.

In the case of forming the low-reflection film by sputtering, the addition of oxygen into the film can be effected by adding an oxygen gas or a carbon dioxide gas to the sputtering gas. Similarly, when a nitrogen gas is added to the sputtering gas, nitrogen is added into the low-reflection film, and when carbon dioxide or carbon monoxide is added, carbon and oxygen are added into the low-reflection film.

The low-reflection film may be composed of not only one layer but also two or more layers. Even when the low-reflection film is composed of two or more layers, the layers each preferably has the construction as described above.

Furthermore, not only when the low-reflection film is the uppermost layer but also when not the uppermost layer, the composition of the low-reflection film is preferably in the above-described range.

The thickness of the light-shielding film is preferably from 90 to 130 nm from the standpoint of setting the OD value in the visible region to be about 4.0. Also, the thickness of the low-reflection film is preferably from 40 to 70 nm (when the low-reflection film is composed of one layer) or from 5 to 60 nm (thickness of one layer in the case where the low-reflection film is composed of two or more layers) from the standpoint of setting the reflectance over the visible region to be 3% or less (excluding the reflectance of the glass).

The film (light-shielding film or low-reflection film) constituting the blank of the present invention is preferably formed by sputtering from the standpoint of durability and uniformity of film thickness. For example, the light-shielding film can be formed by using an Ni—Mo—Fe alloy target and performing sputtering in an inert gas atmosphere or in a mixed gas atmosphere of inert gas and nitrogen gas. The low-reflection film can be formed by using an Ni—Mo—Fe alloy target and performing sputtering in an oxidative gas atmosphere. Accordingly, for forming a light-shielding film and a low-reflection film on a substrate, this can be achieved by continuously performing the above-described methods.

The oxidative gas atmosphere as referred to herein means an atmosphere containing at least either O₂ or CO₂ and further being mixed with a gas such as Ar and N₂. As for the inert gas, one or more gases selected from the group consisting of He, Ne, Ar and Kr gases may be used as the sputtering gas, but an Ar gas is preferred because of stable discharge and low cost.

The sputtering pressure is suitably from 0.1 to 2 Pa, and the back pressure is preferably from 1×10⁻⁶ to 1×10⁻² Pa. In view of durability and productivity, the substrate temperature is preferably from room temperature to 300° C., more preferably from room temperature to 200° C.

In forming a light-shielding film or a low-reflection film, the Ni content in the Ni—Mo—Fe alloy target is preferably from 70 to 92 atm %, more preferably from 70 to 90 atm %, based on the total metal elements in the target. The Mo content is preferably from 8 to 30 atm %, more preferably from 12 to 22 atm %, based on the total metal elements in the target. The Fe content is preferably from 1 to 6 atm % based on the total metal elements in the target.

The present invention also provides a black matrix which ca be formed by patterning the above-described blank. As for the composition and construction of the films (light-shielding film, low-reflection film) in the black matrix, the compositions and constructions of the films of the blank can be applied as it is.

The black matrix of the present invention is formed by coating a photoresist on the above-described blank, printing a wiring pattern, and removing unnecessary portions of the blank such as light-shielding film and anti-reflection film with an etching solution according to the pattern of the photoresist. Examples of the etching solution include a mixture of cerium ammonium nitrate, perchloric acid and water, a mixture of cerium ammonium nitrate, nitric acid and water, and a mixture of phosphoric acid, nitric acid, acetic acid and water.

The present invention also provides a color filter using the above-described black matrix. The color filter is produced by forming red, green and blue color layers by lithography on a substrate having formed thereon the black matrix, and further forming a transparent protective film and a transparent electrically conductive film.

### EXAMPLES

### Examples 1 to 9

A 0.7 mm-thick non-alkali glass substrate was cleaned and then set as a substrate on a sputtering apparatus. On the substrate, a 50 nm-thick low-reflection film was formed by dc magnetron sputtering using an Ni—Mo—Fe alloy target at an atomic percentage (%) of 79/17/4. The sputtering gas was an Ar gas containing 50 vol % of CO₂ gas, the back pressure was 1.3×10⁻³ Pa, the sputtering gas pressure was 0.3 Pa, and the density of electric power applied was 2.2 W/cm². Heating of the substrate was not performed.

After evacuating residual gases, a 110 nm-thick light-shielding film was formed on the low-reflection film by dc magnetron sputtering using an Ni—Mo—Fe alloy target having the composition shown in Table 1, whereby a blank was obtained. As for the sputtering gas, a mixed gas of Ar and nitrogen mixed in the ratio shown in Table 1 was used. The back pressure was 1.3×10⁻³ Pa, the sputtering gas pressure was 0.3 Pa, and the density of electric power applied was 2.1 W/cm². Heating of the substrate was not performed.

The composition of metal components of the light-shielding film in Example 1 was measured by ICP emission spectrometry and found to consist of Ni: 86.2 atm %, Mo: 10.3 atm %, Fe: 3.5 atm %, and Ta: 0 atm %.

The composition of metal components of the light-shielding film in Example 4 was measured by ICP emission spectrometry and found to consist of Ni: 86.7 atm %, Mo: 9.9 atm %, Fe: 3.4 atm %, and Ta: 0 atm %. The content of nitrogen in the light-shielding film in Example 4 was measured by the RBS analysis and the NRA analysis and found to be 4.1 atm %.

The composition of metal components of the light-shielding film in Example 9 was measured by ICP emission spectrometry and found to consist of Ni: 83.8 atm %, Mo: 12.8 atm %, Fe: 3.4 atm %, and Ta: 0 atm %.

The blanks each was measured for low reflectivity, light-shielding property, alkali resistance, heat resistance, water resistance, etching rate of light-shielding film and patterning property, by the following methods. The results are shown in Table 2.

### (1) Low Reflectivity

The reflectance over the visible region (luminous reflectance) was measured from the glass surface side of the blank by using a spectrophotometer (U-4000, manufactured by Hitachi, Ltd.), whereby the low reflectivity was evaluated (excluding the reflectance of the glass). The case where the luminous reflectance was 3% or less was rated as A, and the case of more than 3% was rated as C. Rating A is practically preferred.

### (2) Light Shielding Property

The OD value was measured by an optical densitometer (TD-904, manufactured by Macbeth) to evaluate the light shielding property. The case where the OD value was 3.7 or more was rated as A, and the case of less than 3.7 was rated as C. Rating A is practically preferred.

### (3) Alkali Resistance

The blank was dipped in a 5% NaOH solution at 75° C. for 30 minutes, and the rate of change of the OD value was measured to evaluate the alkali resistance. The case where the rate of change of the OD value was 5% or less was rated as A, and the case of more than 5% was rated as C. Rating A is practically preferred.

### (4) Heat Resistance

After the blank was left standing in an air atmosphere at 250° C. for 30 minutes by using a constant-temperature chamber (PMS-P101, manufactured by ESPEC Corp.), the rate of change of the OD value was measured to evaluate the heat resistance. The case where the rate of change of the OD value was 5% or less was rated as A, and the case of more than 5% was rated as C. Rating A is practically preferred.

### (5) Water Resistance

The blank was dipped in pure water at 80° C. for 60 minutes, and the rate of change of the OD value was measured to evaluate the water resistance. The case where the rate of change of the OD value was 5% or less was rated as A, and the case of more than 5% was rated as C. Rating A is practically preferred.

### (6) Etching Rate of Light-Shielding Film

A film having the same composition as that of the light-shielding film of the blank was formed on a separately prepared non-alkali glass substrate under the same conditions.

The substrate with the light-shielding film was dipped in an etching solution at 30° C. prepared by mixing 13 mass % of ceric ammonium nitrate, 3 mass % of perchloric acid and 84 mass % of water, and the time until the light-shielding film disappeared was measured to evaluate the etching rate of the light-shielding film.

The case where the etching rate was from 1 to 4 nm/sec was rated as A, the case of from 0.5 nm/sec to less than 1 nm/sec or from more than 4 nm/sec to 6 nm/sec was rated as B, and the case of less than 0.5 nm/sec or more than 6 nm/sec was rated as C. This rating was made in consideration of productivity and processability. Rating A or B is practically preferred, and rating A is more preferred.

### (7) Patterning Property

The blank formed was patterned by lithography using an etching solution prepared by mixing 13 mass % of ceric ammonium nitrate, 3 mass % of perchloric acid and 84 mass % of water, whereby the patterning property was evaluated. The case where erosion of the pattern formed was not observed and the line thinning amount of the pattern was 2 μm or less was rated as A, the case where erosion of the pattern was not observed and the line thinning amount of the pattern was from more than 2 μm to 4 μm was rated as B, and the case where erosion of the pattern was observed or the line thinning amount of the pattern was more than 4 μm was rated as C. Rating B or A is practically preferred, and rating A is more preferred.

### Examples 10 to 16

### Comparative Example

On a low-reflection film formed in the same manner as the low-reflection film of Example 1, a 110 nm-thick light-shielding film was formed by dc magnetron sputtering using an Ni—Mo—Fe alloy target or Ni—Mo—Fe—Ta alloy target shown in Table 1 to obtain a blank. As for the sputtering gas, a mixed gas of Ar and nitrogen mixed in the ratio shown in Table 1 was used. The back pressure was 1.3×10⁻³ Pa, the sputtering gas pressure was 0.3 Pa, and the density of electric power applied was 2.1 W/cm². Heating of the substrate was not performed.

The composition of metal components of the light-shielding film in Example 16 was measured by ICP emission spectrometry and found to consist of Ni: 81.9 atm %, Mo: atm %, Fe: 3.4 atm %, and Ta: 0.9 atm %.

The low reflectivity, light shielding property, alkali resistance, heat resistance, water resistance, etching rate of light-shielding film, and patterning property were evaluated in the same manner as in Example 1. The results are shown in Table 2.

TABLE 1

| | | | | | Flow Rate Ratio of | |
|---|---|---|---|---|---|---|
| | Target Composition upon | | | | Sputtering Gas | |
| | Formation of Light- | | | | Formation of Light- | |
| | Shielding Film (atm %) | | | | Shielding Film (vol %) | |
| Example | Ni | Mo | Fe | Ta | Ar | N₂ |
| 1 | 86.5 | 10 | 3.5 | 0 | 100 | 0 |
| 2 | 86.5 | 10 | 3.5 | 0 | 95 | 5 |
| 3 | 86.5 | 10 | 3.5 | 0 | 90 | 10 |
| 4 | 86.5 | 10 | 3.5 | 0 | 85 | 15 |
| 5 | 86.5 | 10 | 3.5 | 0 | 81 | 19 |
| 6 | 83.5 | 13 | 3.5 | 0 | 100 | 0 |
| 7 | 83.5 | 13 | 3.5 | 0 | 95 | 5 |
| 8 | 83.5 | 13 | 3.5 | 0 | 90 | 10 |
| 9 | 83.5 | 13 | 3.5 | 0 | 85 | 15 |
| 10 | 80 | 16.5 | 3.5 | 0 | 100 | 0 |
| 11 | 80 | 16.5 | 3.5 | 0 | 90 | 10 |
| 12 | 80 | 16.5 | 3.5 | 0 | 85 | 15 |
| 13 | 81.5 | 14 | 3.5 | 1 | 100 | 0 |
| 14 | 81.5 | 14 | 3.5 | 1 | 95 | 5 |
| 15 | 81.5 | 14 | 3.5 | 1 | 90 | 10 |
| 16 | 81.5 | 14 | 3.5 | 1 | 85 | 15 |

TABLE 2

| | Low | Light | Alkali | Heat | Water | | |
|---|---|---|---|---|---|---|---|
| | Reflec- | Shielding | Resist- | Resist- | Resist- | Etching | Patterning |
| Example | tivity | Property | ance | ance | ance | Rate | Property |
| 1 | A | A | A | A | A | A | B |
| 2 | A | A | A | A | A | A | B |
| 3 | A | A | A | A | A | A | A |
| 4 | A | A | A | A | A | A | A |
| 5 | A | A | A | A | A | A | A |
| 6 | A | A | A | A | A | A | B |
| 7 | A | A | A | A | A | A | A |
| 8 | A | A | A | A | A | A | A |
| 9 | A | A | A | A | A | A | A |
| 10 | A | A | A | A | C | A | C |
| 11 | A | A | A | A | C | A | C |
| 12 | A | A | A | A | C | C | C |
| 13 | A | A | A | A | C | A | C |
| 14 | A | A | A | A | C | A | C |
| 15 | A | A | A | A | C | A | C |
| 16 | A | A | A | A | C | A | B |

As seen from Examples 13 to 16 in Table 2, when the light-shielding film as the uppermost layer is a film containing Ta, that is, an Ni—Mo—Fe—Ta alloy, the water resistance and patterning property are poor. Also, as seen from Examples 10 to 12 in Table 2, even if the light-shielding film as the uppermost layer is an Ni—Mo—Fe alloy, when the Mo amount is large (specifically, the Mo content is more than 15 atm %), the water resistance and patterning property are poor.

On the other hand, from Examples 1 to 9 in Table 2, it is confirmed that when the light-shielding layer as the uppermost layer is an Ni—Mo—Fe alloy and the Mo amount is 10% and 13%, the water resistance and patterning property are excellent. Also, for example, from comparison between Example 1 and Example 3, it is confirmed that when an appropriate amount of nitrogen is introduced at the formation of the light-shielding film, the patterning property is further improved.

Using each of the blanks of Examples 1 to 9, a black matrix is formed by coating a photoresist, printing a wiring pattern, and removing unnecessary portions with an etching solution. On the substrate having formed thereon the black matrix, red, green and blue color layers are formed by photolithography, and a transparent protective film and a transparent electrically conductive film are further formed in this order to obtain a color filter. From the thus-obtained color filter, a color liquid crystal display device is formed. It is confirmed that the display quality of the color liquid crystal display device formed is improved as compared with the case using the blanks of Comparative Examples.

While the present invention has been described in detail and with reference to specific embodiments thereof, it will be apparent to one skilled in the art that various changes and modifications can be made therein without departing from the spirit and scope thereof.

This application is based on Japanese Patent Application No. 2006-119346 filed on Apr. 24, 2006, the contents of which are incorporated herein by way of reference.

### INDUSTRIAL APPLICABILITY

The black matrix of the present invention has good durability (e.g., water resistance) and patterning property by virtue of being free from Ta in the uppermost layer and therefore, is useful as a black matrix for color liquid crystal display devices.

1. A blank for a black matrix, comprising a substrate having laminated thereon a light-shielding film and a low-reflection film, wherein the uppermost layer of the blank is the light-shielding film or the low-reflection film, the uppermost layer has an Ni content of from 80 to 92 atm % based on the total metal components, the uppermost layer has an Mo content of from 8 to 15 atm % based on the total metal components, and the uppermost layer is free from Ta.

2. The blank as claimed in claim 1, wherein the uppermost layer contains other metals in addition to Ni and Mo, the other metal is Fe, and the upper most layer has an Fe content of from 0.5 to 6 atm % based on the total metal components.

3. The blank as claimed in claim 1, wherein the uppermost layer further contains nitrogen.

4. A blank for a black matrix, comprising a substrate having laminated thereon a low-reflection film and a light-shielding film in this order, wherein the light-shielding film has an Ni content of from 80 to 92 atm % based on the total metal components, the light-shielding film has an Mo content of from 8 to 15 atm % based on the total metal components, and the light-shielding film is free from Ta.

5. The blank as claimed in claim 4, wherein the light-shielding film contains other metals in addition to Ni and Mo, the other metal is Fe, and the light-shielding film has an Fe content of from 0.5 to 6 atm % based on the total metal components.

6. The blank as claimed in claim 4, wherein the light-shielding film further contains nitrogen and the nitrogen content is from 0.5 to 10 atm % based on the total elements in the light-shielding film.

7. The blank as claimed in claim 4, wherein the light-shielding film contains oxygen and carbon and the total content thereof is 4 atm % or less based on the total elements in the light-shielding film.

8. The blank as claimed in claim 4, wherein the low-reflection film has an Ni content of from 70 to 92 atm % based on the total metal components therein and the low-reflection film has an Mo content of from 8 to 30 atm % based on the total metal components therein.

9. The blank as claimed in claim 4, wherein the light-shielding film has a thickness of from 90 to 130 nm.

10. A black matrix formed by patterning the blank claimed in claim 1.

11. A color filter obtained by forming color layers and a transparent electrically conductive film on a substrate having formed thereon the black matrix claimed in claim 10.
